(19) United States
(12) Patent Application Publication
(10) Pub. No.: US 2017/0193993 A1
(43) Pub. Date: Jul. 6, 2017

(54) AUXILIARY APPARATUS AND FAMILY SMART SYSTEM

(71) Applicant: JinXiao Wu, Hsin chu City (TW)

(72) Inventor: JinXiao Wu, Hsin chu City (TW)

(21) Appl. No.: 15/393,732

(22) Filed: Dec. 29, 2016

(30) Foreign Application Priority Data
Dec. 31, 2015 (TW) 104144799
Aug. 1, 2016 (TW) 105124366

(51) Int. Cl. G10L 15/22; G10L 15/30

(52) U.S. Cl. CPC G10L 15/22; G10L 15/30; H04B 3/542

(57) ABSTRACT

An auxiliary apparatus includes a communication unit, a voice receiving unit, a voice play unit, and a processing unit. The processing unit receives a first voice signal by the voice receiving unit to trigger a process program of the processing unit, and receives a second voice signal by the voice receiving unit to transmit the second voice signal to at least one portable electronic device. The processing unit receives a third voice signal transmitted from the at least one portable electronic device by the communication unit, performs a relevant operation corresponding to the process program according to the third voice signal and transmits the third voice signal to the voice play unit to play the third voice signal. The third voice signal corresponds to the second voice signal. The third voice signal is generated in response to the second voice signal by the at least one portable electronic device.

### CROSS REFERENCE TO RELATED APPLICATION

This application claims the priority benefit of Taiwan Patent Application Serial Number 104144799, filed on Dec. 31, 2015 and Taiwan Patent Application Serial Number 105124366, filed on Aug. 1, 2016, the full disclosures of which are incorporated herein by reference.

### BACKGROUND

Technical Field

This disclosure generally relates to an auxiliary apparatus and, more particularly, to an auxiliary apparatus and a family smart system for performing a voice control operation to an portable electronic apparatus remotely.

Related Art

With the progress of science and technology, portable electronic apparatuses, such as smart phones, tablet computers, and etc., have become indispensable in daily life. Presently, most of the portable electronic apparatuses are configured with voice control function, that is, the user may generate a voice to control the portable electronic apparatus, such that the portable electronic apparatus performs a corresponding operation according the voice generated by the user.

In general, when the user wants to perform a voice control operation for the portable electronic apparatus, the user is only usually capable of performing the voice control operation in the vicinity of the portable electronic apparatus. However, the users may not always be in the vicinity of the portable electronic device, for example, the user may be in the office A or the room A and the portable electronic apparatus is located in the office B or the room B. If the user wants to perform the voice control operation for the portable electronic apparatus, the user has to move to the office B or the room B from the office A or the room, so as to perform the voice control operation, thereby causing an inconvenience of usage. Therefore, the voice control operation for the portable electronic apparatus needs improvement.

### SUMMARY

The disclosure provides an auxiliary apparatus and a family smart system, such that a voice control operation is performed for a portable electronic apparatus in a far distance, so as to increase a convenience of usage.

The disclosure provides an auxiliary apparatus, which includes a communication unit, a voice receiving unit, a voice playing unit and a processing unit. The processing unit is coupled to the communication unit, the voice receiving unit and the voice playing unit. The processing unit receives a first voice signal by the voice receiving unit to start a processing process of the processing unit, and receives a second voice signal by the voice receiving unit to transmit the second voice signal to at least one portable electronic apparatus through the communication unit. The processing unit receives a third voice signal transmitted by the at least one portable electronic apparatus through the communication unit, performs a corresponding operation corresponding to the processing process according to the third voice signal, and transmits the third voice signal to the voice playing unit, so as to play the third voice signal. The third voice signal corresponds to the second voice signal, and the third voice signal is generated by the at least one portable electronic apparatus in response to the second voice signal.

The disclosure further provides a system including a plurality of auxiliary apparatuses mentioned above, wherein the plurality of auxiliary apparatuses communicate with each other, such that the at least one portable electronic apparatus outputs the third voice signal to one of the plurality of the auxiliary apparatuses and then the auxiliary apparatus outputs the third voice signal to the remaining auxiliary apparatuses.

The disclosure further provides a family smart system, which includes at least one auxiliary apparatus and at least one base body. The at least one auxiliary apparatus includes a first communication unit, a voice receiving unit, a first voice playing unit, a first processing unit. The first processing unit is coupled to the first communication unit, the voice receiving unit and the first voice playing unit. The first processing unit receives a first voice signal by the voice receiving unit to start a processing process of the first processing unit, and receives a second voice signal by the voice receiving unit to output the second voice signal through the first communication unit. The at least one base body is coupled to the first communication unit, receives the second voice signal, transmits the second voice signal to the at least one portable electronic apparatus through a wireless manner, and wirelessly receives a third voice signal generated by the at least one portable electronic apparatus in response to the second voice signal. The first processing unit receives the third voice signal through the first communication unit, performs a corresponding operation corresponding to the processing process according to the third voice signal, and transmits the third voice signal to the first voice playing unit, so as to play the third voice signal.

According to the auxiliary apparatus and the family smart system of the disclosure, the auxiliary apparatus transmits the second voice signal generated by the user to the at least one portable electronic apparatus to process or the auxiliary apparatus and the base body transmits the second voice signal generated by the user to the at least one portable electronic apparatus to process, then the auxiliary apparatus receives the third voice signal generated by the at least one portable electronic apparatus in response to the second voice signal, so as to perform the corresponding operation and play the third voice signal corresponding to the second voice signal according to the third voice signal, or the auxiliary apparatus and the base body receive the third voice signal generated by the at least one portable electronic apparatus in response to the second voice signal, so as to perform the corresponding operation and play the third voice signal corresponding to the second voice signal according to the third voice signal. Therefore, the user may still perform the voice control operation for the at least one portable electronic apparatus through the auxiliary apparatus or the auxiliary apparatuses and the base body in a far distance, thereby increasing a convenience of usage.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 shows a schematic diagram of an auxiliary apparatus according to an embodiment of the disclosure;

FIG. 2 shows another schematic diagram of an auxiliary apparatus according to an embodiment of the disclosure;

FIG. 3 shows a schematic diagram of a family smart system according to an embodiment of the disclosure;

FIG. 4 shows a schematic diagram of a base body according to an embodiment of the disclosure;

FIG. 5 shows a schematic diagram of a family smart system according to another embodiment of the disclosure;

FIG. 6 shows a schematic diagram of a plurality of auxiliary apparatuses according to an embodiment of the disclosure;

FIG. 7 shows another schematic of a family smart system according to an embodiment of the disclosure.

### DETAILED DESCRIPTION OF THE EMBODIMENTS

The disclosure will now be described more fully hereinafter with reference to the accompanying drawings, in which exemplary embodiments of the invention are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

In the following embodiment, the same reference numerals is used to refer to the same or similar elements throughout.

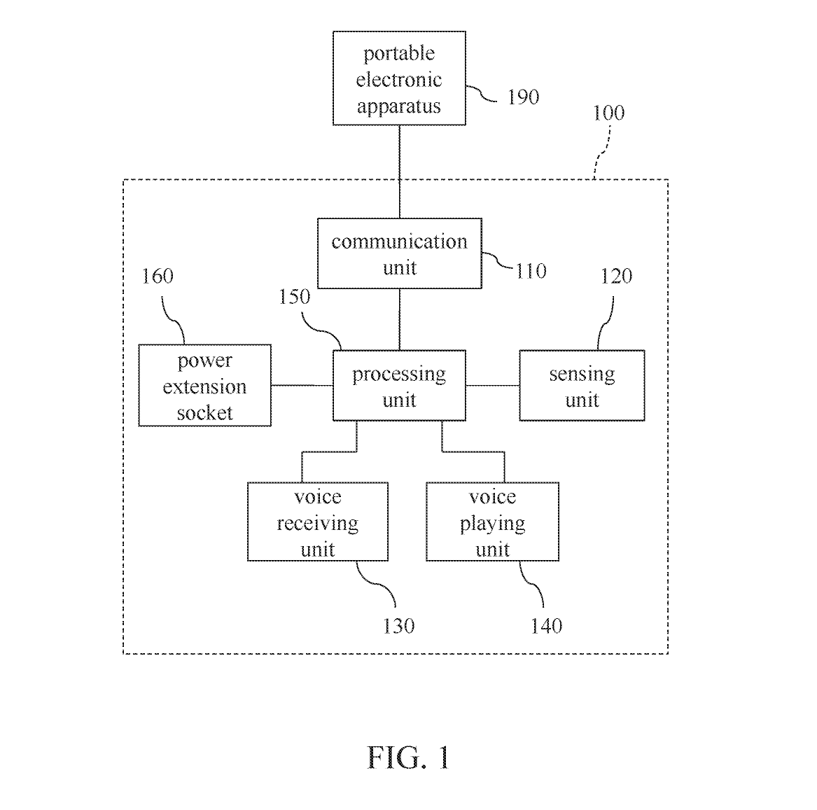

FIG. 1 shows a schematic diagram of an auxiliary apparatus according to an embodiment of the disclosure. The auxiliary apparatus 100 of the disclosure is configured in a local small area, such as a company or a home, and further may be configured in a company office or a home room.

The auxiliary apparatus 100 includes a communication unit 110, a voice receiving unit 130, a voice playing unit 140 and a processing unit 150. The communication unit 110 may adopt a wire manner or a wireless manner, or may be equipped with a wire manner and a wireless manner at the same time. The wireless manner may adopt, for example, a wireless fidelity (WiFi) communication protocol to connect to a wireless local area network. The wire manner may adopt, for example, a power line communication (PLC) protocol, also known as a power line network. This is a technique for transmitting the data or the information in a digital signal processing method by using the existing power line. In the embodiment, the communication unit 110 includes the wire manner and the wireless manner, such as a first communication protocol and a second communication protocol. The communication unit 110 is, for example, connected to a portable electronic apparatus 190 through the first communication protocol, and the communication unit 110 is, for example, connected to other auxiliary apparatus through the second communication protocol. In the embodiment, the first communication protocol is, for example, a bluetooth or the WiFi, and the second communication protocol is, for example, the WiFi or the PLC. Therefore, the communication unit 100 conforms a WiFi communication protocol or a power line communication protocol or conforms the WiFi communication protocol and the power line communication protocol at the same time.

The voice receiving unit 130 includes, for example, one or more microphones, so as to receives an external voice signal. The voice playing unit 140 is, for example, a horn or a speaker, so as to play a voice signal.

The processing unit 150 is coupled to the communication unit 110, the voice receiving unit 130 and the voice playing unit 140, receives a first voice signal by the voice receiving unit 130 to start a processing process of the processing unit 150, and receives a second voice signal by the voice receiving unit 130 to transmit the second voice signal to the portable electronic apparatus 190 through the communication unit 110.

Specifically, after the voice receiving unit 130 is started, the processing unit 150 receives the first voice signal through the voice receiving unit 130 and starts a processing process of the processing unit 150 to perform a subsequent processing. Then, the processing unit 150 receives the second voice signal through the voice receiving unit 130 and transmits the second voice signal to the portable electronic apparatus 190 through the communication unit 110. In the embodiment, the portable electronic apparatus 190 may be a smart phone or a tablet computer, and on which an application may be performed, so as to start a voice control mode. The first voice signal and the second voice signal may be, for example, generated by a user.

Afterward, when the portable electronic apparatus 190 receives the second voice signal, the portable electronic apparatus 190 may perform the application corresponding to the second voice signal to correspondingly process the second voice signal, so as to generate a third voice signal in response to the second voice signal.

The processing unit 150 receives the third voice signal transmitted by the portable electronic apparatus 190 through the communication unit 110 in the wireless manner, performs a corresponding operation corresponding to the processing process according to the third voice signal, and transmits the third voice signal to the voice playing unit 140, such that the voice playing unit 140 may play the third voice signal. Therefore, when the user and the portable electronic apparatus 190 locates at different offices or rooms, the user may still perform a voice control operation to the portable electronic apparatus 190 through the auxiliary apparatus 100 in a far distance, and obtain a processing result corresponding to the second voice signal generated by the user through the third voice signal, thereby increasing a convenience of usage.

In another embodiment, as shown in FIG. 1, the auxiliary apparatus 100 further includes a sensing unit 120. The sensing unit 120 senses whether an object approaches the auxiliary apparatus 100 to generate a sensing signal. Wherein, the object is, for example, the user, and the sensing unit 120 is, for example, an infrared sensor or image sensor. For example, when the sensing unit 120 senses that the object approaches the auxiliary apparatus 100, the sensing unit 120 generates, for example, a sensing signal with high logic level, which indicates that the object appears within a sensing range of the sensing unit 120; when the sensing unit 120 senses that the object does not approach the auxiliary apparatus 100, the sensing unit 120 generates, for example, a sensing signal with low logic level, which indicates that the object does not appear within a sensing range of the sensing unit 120.

In this embodiment, the processing unit 150 receives the sensing signal, and triggers the voice receiving unit 130 according to the sensing signal. That is, when the sensing signal received by the processing unit 150 is high logic level, the processing unit 150 may generate a triggering signal to trigger the voice receiving unit 130, such that the voice receiving unit 130 may perform an operation for receiving the voice signal; when the sensing signal received by the processing unit 150 is low logic level, the processing unit 150 does not generate the triggering signal and does not trigger the voice receiving unit 130, such that the voice receiving unit 130 does not perform the operation for receiving the voice signal.

In another embodiment, the auxiliary apparatus 100 further includes a power extension socket 160. The power extension socket 160 is coupled to the processing unit 150 and the power extension socket 160 may supply a power to an external apparatus connected to the power extension socket 160. Since the auxiliary apparatus 110 may directly be connected to the power socket in the company or home to obtain a working power and occupy the power socket, the power extension socket 160 disposed on the auxiliary apparatus 100 may additionally supply the power to the external apparatus, thus it also increases a convenience of usage.

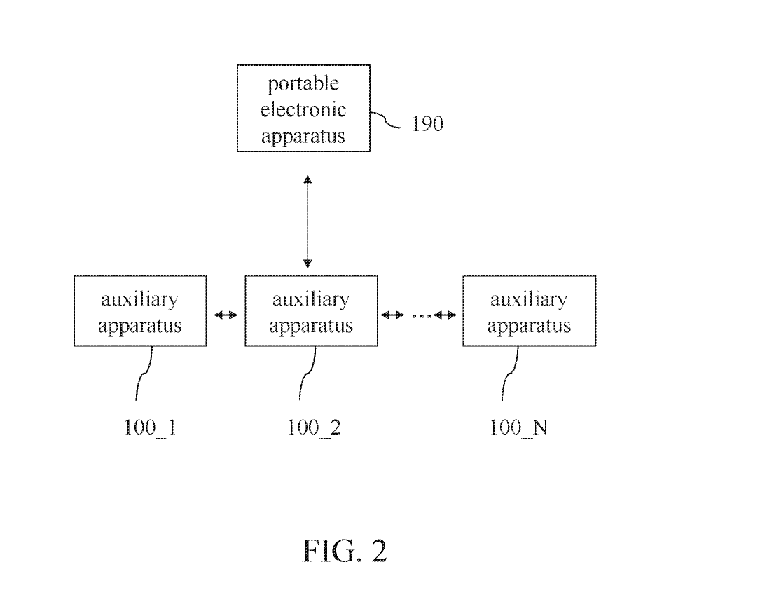

FIG. 2 shows another schematic diagram of an auxiliary apparatus according to an embodiment of the disclosure. The portable electronic apparatus 190 communicates with a plurality of auxiliary apparatuses 100_1˜100_N. The auxiliary apparatuses 100_1˜100_N are configured in a local small area, such as a company or a home, and further may be configured in a company office or a home room. Further, the auxiliary apparatuses 100_1˜100_N may also be communicated with each other, such the portable electronic apparatus 190 may transmit the third voice signal to the corresponding auxiliary apparatus generating the second voice signal, such as the auxiliary apparatus 100_1, and then the third voice signal is outputted to other auxiliary apparatuses 100_2˜100N at the same time through the auxiliary apparatus 100_1, or the third voice signal is transmitted in sequence through a one by one transmission manner (for example, the auxiliary apparatus 100_1 transmits the third voice signal to the auxiliary apparatus 100_2, the auxiliary apparatus 100_2 transmits the third voice signal to the auxiliary apparatus 100_3, . . . , the auxiliary apparatus 100_N−1 transmits the third voice signal to the auxiliary apparatus 100_N), such that the auxiliary apparatuses 100_1˜100_N perform the corresponding operation corresponding the processing process, and play the third voice signal corresponding to the second voice signal.

The internal components and related operations of the auxiliary apparatuses 100_1˜100_N may refer to the description of the embodiment of the auxiliary apparatus 100 in FIG. 1, and then the description thereof is omitted.

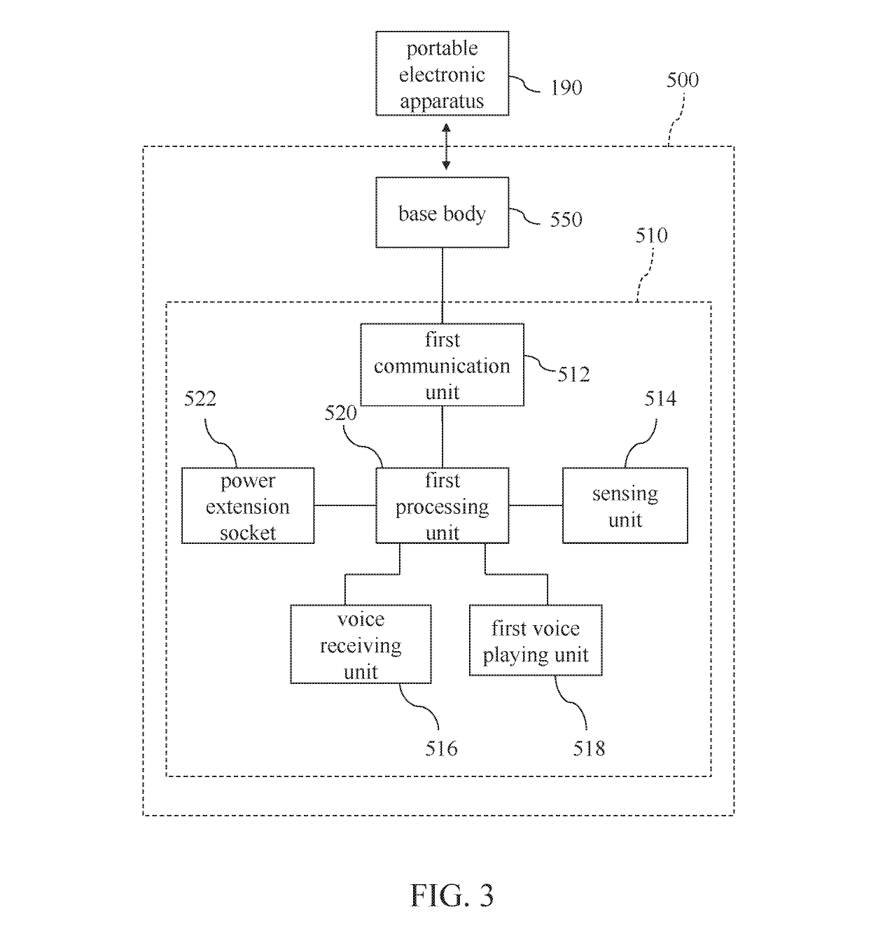

FIG. 3 shows a schematic diagram of a family smart system according to an embodiment of the disclosure. The family smart system 500 includes an auxiliary apparatus 510 and a base body 550. The family smart system 500 is configured in a local small area, such as a company or a home, and the auxiliary apparatus 510 and the base body 550 are configured in different offices of the company or different rooms of the home.

The auxiliary apparatus 510 includes a first communication unit 512, a sensing unit 514, a voice receiving unit 516, a first voice playing unit 518 and a first processing unit 520. The first communication unit 512, the voice receiving unit 516 and the first voice playing unit 518 are the same as or similar to the communication unit 110, the voice receiving unit 130 and the voice playing unit 140 in FIG. 1, they may refer to the description of the embodiment in FIG. 1, and then the description thereof is omitted. In another embodiment, the auxiliary apparatus 500 includes the sensing unit 514, which is also similar to the sensing unit 120, it may refer to the description of the embodiment in FIG. 1, and then the description thereof is omitted.

The first processing unit 520 is coupled to the first communication unit 512, the voice receiving unit 516 and the first voice playing unit 518.

After the voice receiving unit 516 is started, the first processing unit 520 receives the first voice signal through the voice receiving unit 516 and starts a processing process of the first processing unit 520 to perform a subsequent processing. Then, the first processing unit 520 receives the second voice signal through the voice receiving unit 516 and transmits the second voice signal to the base body 550 through the first communication unit 512. The first voice signal and the second voice signal are, for example, generated by the user. In one embodiment, the base body 550 is coupled to the first communication unit 512 through the wireless manner, wherein the wireless manner is, for example, WiFi. In another embodiment, the base body 550 is coupled to the first communication unit 512 through the wire manner, wherein the wire manner is, for example, a power line control (PLC).

The base body 550 communicates with the first communication unit 512, receives the second voice signal, and transmits the second voice signal to a portable electronic apparatus 190 through the wireless manner. In the embodiment, the portable electronic apparatus 190 may be a smart phone or a tablet computer, and on which an application may be performed, so as to start a voice control mode.

Afterward, when the portable electronic apparatus 190 receives the second voice signal, the portable electronic apparatus 190 may perform the application corresponding to the second voice signal to correspondingly process the second voice signal, so as to generate a third voice signal in response to the second voice signal.

The base body 550 may wirelessly receive a third voice signal generated by the portable electronic apparatus 190 in response to the second voice signal, and outputs the third voice signal to the first communication unit 512.

Then, the first processing unit 520 of the auxiliary apparatus 510 receives the third voice signal through the first communication unit 512, performs a corresponding operation corresponding to the processing process according to the third voice signal, and transmits the third voice signal to the voice playing unit 518, so as to play the third voice signal. Therefore, when the user and the portable electronic apparatus 190 locates at different offices or rooms, the user may still perform a voice control operation to the portable electronic apparatus 190 through the auxiliary apparatus 510 and the base body 550 in a far distance, and obtain a processing result corresponding to the second voice signal generated by the user through the third voice signal, thereby increasing a convenience of usage.

In another embodiment, as shown in FIG. 3, the auxiliary apparatus 550 further includes a sensing unit 514. The sensing unit 514 senses whether an object approaches the auxiliary apparatus 550 to generate a sensing signal. Wherein, the object is, for example, the user, and the sensing unit 514 is, for example, an infrared sensor or image sensor. For example, when the sensing unit 514 senses that the object approaches the auxiliary apparatus 550, the sensing unit 514 generates, for example, a sensing signal with high logic level, which indicates that the object appears within a sensing range of the sensing unit 514; when the sensing unit 514 senses that the object does not approach the auxiliary apparatus 550, the sensing unit 514 generates, for example, a sensing signal with low logic level, which indicates that the object does not appear within a sensing range of the sensing unit 514.

In this embodiment, the first processing unit 520 receives the sensing signal, and triggers the voice receiving unit 516 according to the sensing signal. That is, when the sensing signal received by the first processing unit 520 is high logic level, the first processing unit 520 may generate a triggering signal to trigger the voice receiving unit 516, such that the voice receiving unit 516 may perform an operation for receiving the voice signal; when the sensing signal received by the first processing unit 520 is low logic level, the processing unit 520 does not generate the triggering signal and does not trigger the voice receiving unit 516, such that the voice receiving unit 516 does not perform the operation for receiving the voice signal.

In another embodiment, the auxiliary apparatus 510 further includes a power extension socket 522. The power extension socket 522 is coupled to the processing unit 520 and the power extension socket 522 may supply a power to an external apparatus connected to the power extension socket 522. Since the auxiliary apparatus 510 may directly be connected to the power socket in the company or home to obtain a working power and occupy the power socket, the power extension socket 522 disposed on the auxiliary apparatus 510 may additionally supply the power to the external apparatus, thus it also increases a convenience of usage.

The above embodiment only describes the related operations of the base body 550, and a detail internal structure of base body 550 is described as follows.

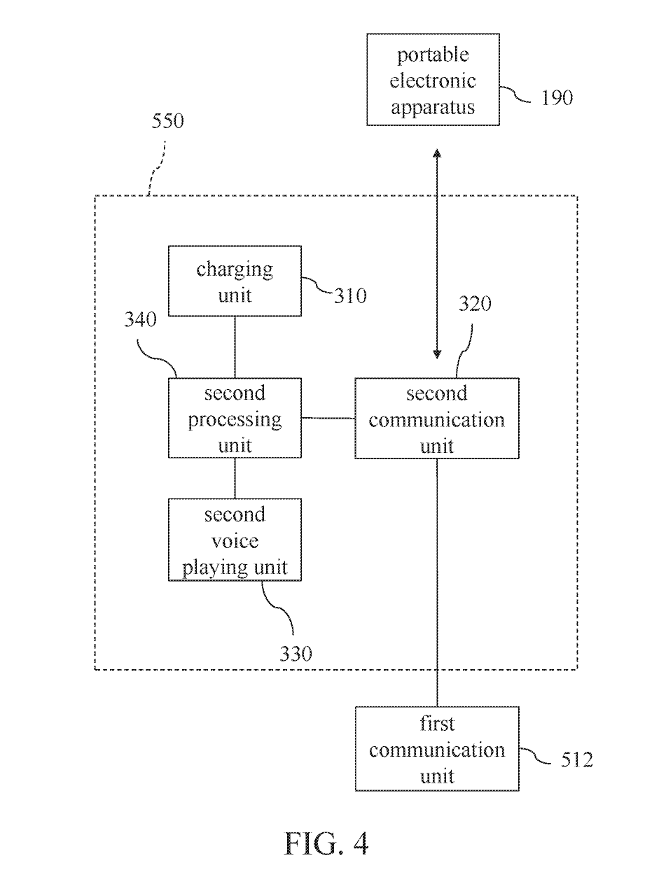

FIG. 4 shows a schematic diagram of a base body according to an embodiment of the disclosure. The base body 550 includes a charging unit 310, a second communication unit 320, a second voice playing unit 330 and a second processing unit 340.

The charging unit 310 is suitable to connect to the portable electronic apparatus 190. That is, when the portable electronic apparatus 190 is connected to the charging unit 310 by the user, the charging unit 310 may charge the portable electronic apparatus 190.

The second communication unit 320 is coupled to the first communication unit and the portable electronic apparatus 190. The second communication unit 320 includes, for example, a first communication protocol and a second communication protocol, wherein the second communication unit 320 is, for example, connected to the portable electronic apparatus 190 through the first communication protocol and the second communication unit 320 is, for example, connected to the first communication unit through the second communication protocol. In the embodiment, the first communication protocol is, for example, a bluetooth or a WiFi, and the second communication protocol is, for example, a WiFi or a PLC. In this time, the first communication 512 includes, for example, a WiFi communication protocol or a power line control.

When the first communication protocol is the WiFi, the base body 550 may include the charging unit 310, and the charging unit 310 is suitable to connect to the portable electronic apparatus 190, such that the portable electronic apparatus 190 and the base body 550 may have good wireless communication signal since they are close to each other. That is, when the portable electronic apparatus 190 is connected to the charging unit 310 by the user, the charging unit 310 may charge the portable electronic apparatus 190.

The second voice playing unit 330 is, for example, a horn or a speaker, which plays a voice signal.

The second processing unit 340 is coupled to the charging unit 310, the second communication unit 320 and the second voice playing unit 330. The second processing unit 340 detects a connection state of the charging unit 310 and the portable electronic apparatus 190. That is, the second processing unit 340 may detect whether the charging unit 310 is connected to the portable electronic apparatus 190.

The second processing unit 340 receives the second voice signal through the second communication unit 320, and transmits the second voice signal to the portable electronic apparatus 190 through the second communication unit 320 according to the connection state. That is, the second processing unit 340 may receive the second voice signal received through the second communication unit 320 in the second communication protocol and transmit the second voice signal to the portable electronic apparatus 190 through the second communication unit 320 in the first communication protocol.

Afterward, the second processing unit 340 may wirelessly receive the third voice signal generated by the portable electronic apparatus 190 in response to the second voice signal through the second communication unit 320, and output the third voice signal to the first communication 512 through the second communication unit 320.

In the above embodiment, a number of the auxiliary apparatus 510 is, for example, one, but is not limited to the disclosure. Depending on a requirement of the user, the number of the auxiliary apparatus 510 is set as two or more than two. Another example is provided as follows.

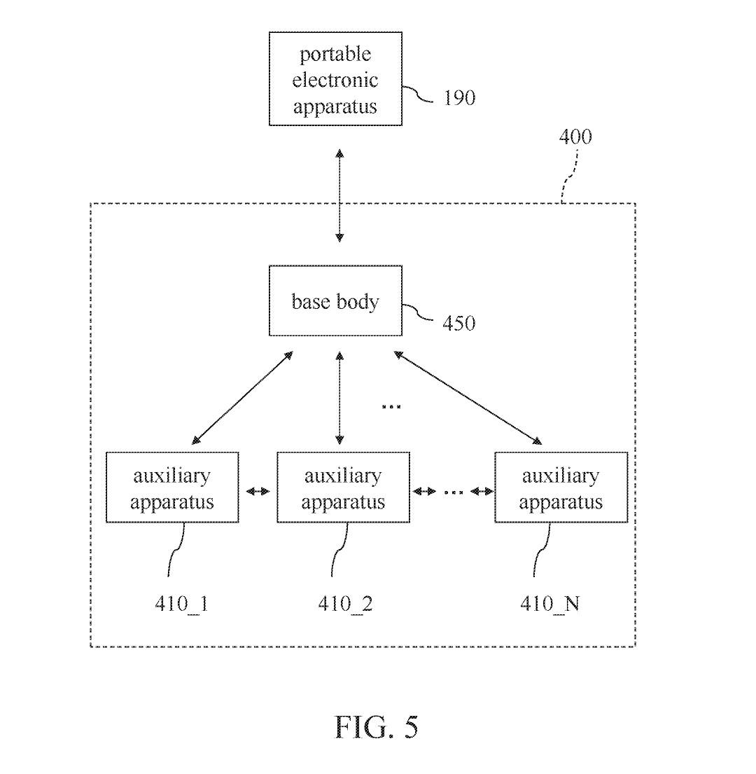

FIG. 5 shows a schematic diagram of a family smart system according to another embodiment of the disclosure. The family smart system 400 includes a plurality of auxiliary apparatuses 410_1˜410_N and a base body 450, wherein N is a positive integer greater than 1. In the embodiment, the family smart system 400 is configured in a local small area, such as a company or a home, and the auxiliary apparatuses 410_1˜410_N and the base body 450 are configured in different offices of the company or different rooms of the home.

The internal components and the related operations of the auxiliary apparatuses 410_1˜410_N may refer to the description of the embodiment of the auxiliary apparatus 510 in FIG. 3, and then the description thereof is omitted. Additionally, the internal components and the related operations of the of the base body 450 may refer to the description of the embodiment of the base body 550 in FIG. 3 and FIG. 4, and then the description thereof is omitted.

Furthermore, when the base body 450 receives the third voice signal generated by the portable electronic apparatus 190 in response to the second voice signal, the base body 450 may output the third voice signal to the corresponding auxiliary apparatus generating the second voice signal or output the third voice signal to all of the auxiliary apparatuses 410_1˜410_N at the same time, such the auxiliary apparatus(es) may perform the corresponding process corresponding the processing process according to the third voice signal, and play the third voice signal corresponding to the second voice signal.

Moreover, the auxiliary apparatuses 410_1˜410_N may also be communicated with each other, such that the base body 450 may output the third voice signal to the corresponding auxiliary apparatus generating the second voice signal, such as the auxiliary apparatus 410_1, and then the third voice signal is outputted to other auxiliary apparatuses 410_2˜410_N at the same time through the auxiliary apparatus 410_1, or the third voice signal is transmitted in sequence through a one by one transmission manner (for example, the auxiliary apparatus 410_1 transmits the third voice signal to the auxiliary apparatus 410_2, the auxiliary apparatus 410_2 transmits the third voice signal to the auxiliary apparatus 410_3, . . . , the auxiliary apparatus 410_N−1 transmits the third voice signal to the auxiliary apparatus 410_N), such that the auxiliary apparatuses 410_1˜410_N perform the corresponding operation corresponding the processing process, and play the third voice signal corresponding to the second voice signal.

Therefore, when the user and the portable electronic apparatus 190 locates at different offices or rooms, the user may still perform a voice control operation to the portable electronic apparatus 190 through the auxiliary apparatuses 410_1˜410_N and the base body 450 in a far distance, thereby increasing a convenience of usage.

In the above embodiment, the auxiliary apparatus and the family smart system only correspond to a single portable electronic apparatus 190, but is not limited to the disclosure. The auxiliary apparatus and the family smart system may correspond to a plurality of portable electronic apparatuses, analyze and identify the first voice signal to match the corresponding portable electronic apparatus and perform a subsequent process. Another example is provided as follows.

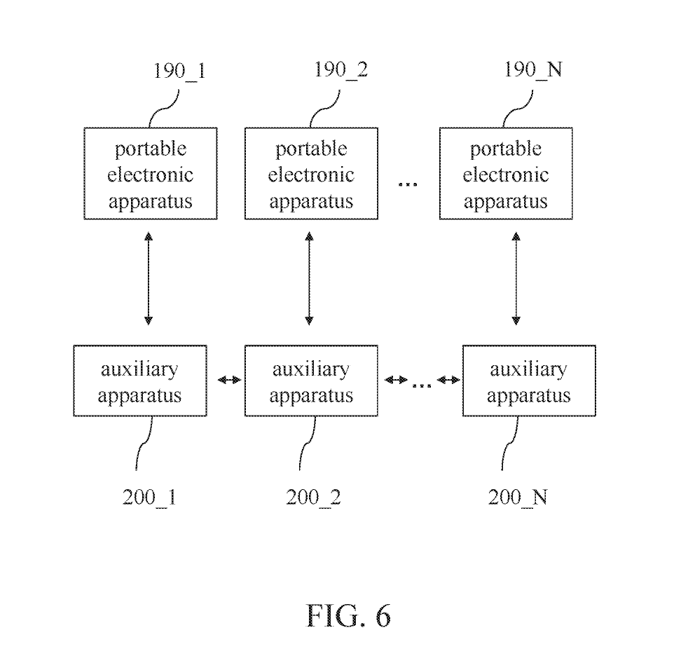

FIG. 6 shows a schematic diagram of a plurality of auxiliary apparatuses according to an embodiment of the disclosure. The auxiliary apparatuses 200_1˜200_N may be communicated with each other, and the internal components and the related operations of the auxiliary apparatuses 200_1˜200_N may refer to the description of the embodiment of the auxiliary apparatus 200 in FIG. 1, and then the description thereof is omitted.

In the embodiment, the auxiliary apparatuses 200_1˜200_N correspond to a plurality of portable electronic apparatuses 190_1˜190_N, and each of the auxiliary apparatuses 200_1˜200_N may be configured with a lookup table, wherein the lookup table records a corresponding relationship of a keyword and the portable electronic apparatus. For example, the keyword “Hello Jeffery” corresponds to the portable electronic apparatus 190_1, the keyword “Hello Jack” corresponds to the portable electronic apparatus 190_2, and other keywords and other portable electronic apparatuses may refer to the above description. The auxiliary apparatuses 200_1˜200_N are, for example, one by one connected to the portable electronic apparatuses 190_1˜190_N. That is, the auxiliary apparatus 200_1 is connected to the portable electronic apparatuses 190_1, the auxiliary apparatus 200_2 is connected to the portable electronic apparatuses 190_2, . . . , the auxiliary apparatus 200_N is connected to the portable electronic apparatuses 190_N.

In one embodiment, after one of the auxiliary apparatuses 200_1˜200_N (for example, the auxiliary apparatus 200_1 connected to the portable electronic apparatus 190_1) receives the first audio signal, the auxiliary apparatus 200_1 may further analyze and identify the first voice signal to obtain a keyword of the first voice signal, such as “Hello Jeffery.” Then, the auxiliary apparatus 200_1 may search in the lookup table according to the keyword of the first voice signal, so as to find a portable electronic apparatus corresponding to the first voice signal, such as the portable electronic apparatus 190_1, and an auxiliary apparatus connected to the portable electronic apparatus 190_1, such as the auxiliary apparatus 200_1.

Since the portable electronic apparatus corresponding to the first voice signal is the portable electronic apparatus 190_1 and the auxiliary apparatus connected to the portable electronic apparatus 190_1 is the auxiliary apparatus 200_1, the auxiliary apparatus 200_1 receives the second voice signal and then transmits the second voice signal to the portable electronic apparatus 190_1. After the portable electronic apparatus 190_1 receives the second voice signal, the portable electronic apparatus 190_1 generates the third voice signal according to the second voice signal, wherein the third voice signal is served as the result in response to the second voice signal.

Afterward, the auxiliary apparatus 200_1 receives the third voice signal transmitted by the portable electronic apparatus 190_1 through the wireless manner, so as to perform the corresponding operation corresponding to the processing process and play the third voice signal according to the third voice signal.

In another embodiment, after one of the auxiliary apparatuses 200_1˜200_N (for example, the auxiliary apparatus 200_1 connected to the portable electronic apparatus 190_1) receives the first audio signal, the auxiliary apparatus 200_1 may further analyze and identify the first voice signal to obtain a keyword of the first voice signal, such as “Hello Jack.” Then, the auxiliary apparatus 200_1 may search in the lookup table according to the keyword of the first voice signal, so as to find a portable electronic apparatus corresponding to the first voice signal, such as the portable electronic apparatus 190_2, and an auxiliary apparatus connected to the portable electronic apparatus 190_2, such as the auxiliary apparatus 200_2.

Afterward, the auxiliary apparatus 200_1 may receive the second voice signal and transmits the second voice signal to the auxiliary apparatus 200_2 connected to the portable electronic apparatus 190_2, and the auxiliary apparatus 200_2 transmits the second voice signal to the portable electronic apparatus 190_2. After the portable electronic apparatus 190_2 receives the second voice signal, the portable electronic apparatus 190_2 may generate the third voice signal according to the second voice signal, wherein the third voice signal is served as the result in response to the second voice signal.

Then, The auxiliary apparatus 200_2 receives the third voice signal transmitted by the portable electronic apparatus 190_2 through the wireless manner, and transmits third voice signal to the auxiliary apparatus 200_1 (i.e. the auxiliary apparatus receiving the first voice signal) initially transmitting the second signal directly or through other auxiliary apparatuses, such that the auxiliary apparatus 200_1 receives the third voice signal, and performs the corresponding operation corresponding to the processing process and play the third voice signal according to the third voice signal. A communication manner among the auxiliary apparatus 200_1, the auxiliary apparatus 200_2 and the remaining portable electronic apparatuses 190_2˜190_N, or a communication manner among each of other auxiliary apparatuses 200_2˜200_N and each of the portable electronic apparatuses 190_2˜190_N may refer to the description of the above embodiments, and the description thereof is omitted.

In the above embodiment, the lookup table records the corresponding relationship of the keyword and the portable electronic apparatus, but is not limited to the disclosure. In another embodiment, the lookup table configured in each of the auxiliary apparatuses records, for example, a corresponding relationship of a voiceprint and the portable electronic apparatus. For example, the voiceprint “A” corresponds to the portable electronic apparatus 190_1, the voiceprint “B” corresponds to the portable electronic apparatus 190_2, and other voiceprints and other portable electronic apparatuses may refer to the above description. Wherein the voiceprint “A,” the voiceprint “B,” . . . correspond to the same word, such as but not limited to “Hello Jeffery.”

In one embodiment, after one of the auxiliary apparatuses 200_1˜200_N (for example, the auxiliary apparatus 200_1 connected to the portable electronic apparatus 190_1) receives the first audio signal, the auxiliary apparatus 200_1 may further analyze and identify the first voice signal to obtain the word and the corresponding voiceprint of the first voice signal, such as “Hello Jeffery” and the corresponding voiceprint “A.” Then, the auxiliary apparatus 200_1 may search and compare in the lookup table according to the voiceprint of the first voice signal, so as to find a portable electronic apparatus corresponding to the first voice signal, such as the portable electronic apparatus 190_1, and an auxiliary apparatus connected to the portable electronic apparatus 190_1, such as the auxiliary apparatus 200_1.

Since the portable electronic apparatus corresponding to the first voice signal is the portable electronic apparatus 190_1 and the auxiliary apparatus connected to the portable electronic apparatus 190_1 is the auxiliary apparatus 200_1, the auxiliary apparatus 200_1 receives the second voice signal and then transmits the second voice signal to the portable electronic apparatus 190_1. After the portable electronic apparatus 190_1 receives the second voice signal, the portable electronic apparatus 190_1 generates the third voice signal according to the second voice signal, wherein the third voice signal is served as the result in response to the second voice signal.

Afterward, the auxiliary apparatus 200_1 receives the third voice signal transmitted by the portable electronic apparatus 190_1 through the wireless manner, so as to perform the corresponding operation corresponding to the processing process and play the third voice signal according to the third voice signal.

In another embodiment, after one of the auxiliary apparatuses 200_1˜200_N (for example, the auxiliary apparatus 200_1 connected to the portable electronic apparatus 190_1) receives the first audio signal, the auxiliary apparatus 200_1 may further analyze and identify the first voice signal to obtain the word and the corresponding voiceprint of the first voice signal, such as “Hello Jeffery” and the corresponding voiceprint “B.” Then, the auxiliary apparatus 200_1 may search and compare in the lookup table according to the voiceprint of the first voice signal, so as to find a portable electronic apparatus corresponding to the first voice signal, such as the portable electronic apparatus 190_2, and an auxiliary apparatus connected to the portable electronic apparatus 190_2, such as the auxiliary apparatus 200_2.

Afterward, the auxiliary apparatus 200_1 may receive the second voice signal and transmits the second voice signal to the auxiliary apparatus 200_2 connected to the portable electronic apparatus 190_2, and the auxiliary apparatus 200_2 transmits the second voice signal to the portable electronic apparatus 190_2. After the portable electronic apparatus 190_2 receives the second voice signal, the portable electronic apparatus 190_2 may generate the third voice signal according to the second voice signal, wherein the third voice signal is served as the result in response to the second voice signal.

Then, the auxiliary apparatus 200_2 receives the third voice signal transmitted by the portable electronic apparatus 190_2 through the wireless manner, and transmits third voice signal to the auxiliary apparatus 200_1 (i.e. the auxiliary apparatus receiving the first voice signal) initially transmitting the second signal directly or through other auxiliary apparatuses, such that the auxiliary apparatus 200_1 receives the third voice signal, and performs the corresponding operation corresponding to the processing process and play the third voice signal according to the third voice signal. A communication manner among the auxiliary apparatus 200_1, the auxiliary apparatus 200_2 and the remaining portable electronic apparatuses 190_2˜190_N, or a communication manner among each of other auxiliary apparatuses 200_2˜200_N and each of the portable electronic apparatuses 190_2˜190_N may refer to the description of the above embodiments, and the description thereof is omitted.

Therefore, the auxiliary apparatuses 200_1˜200_N may correspond to the portable electronic apparatuses 190_1˜190_N, and analyze and identify the different first voice signal to match to the corresponding portable electronic apparatus, such that each of the auxiliary apparatuses 200_1˜200_N may transmits the following second voice signal to the corresponding portable electronic apparatus and receive the third voice signal transmitted by the corresponding portable electronic apparatus to perform the subsequent process, thereby increasing a convenience of usage.

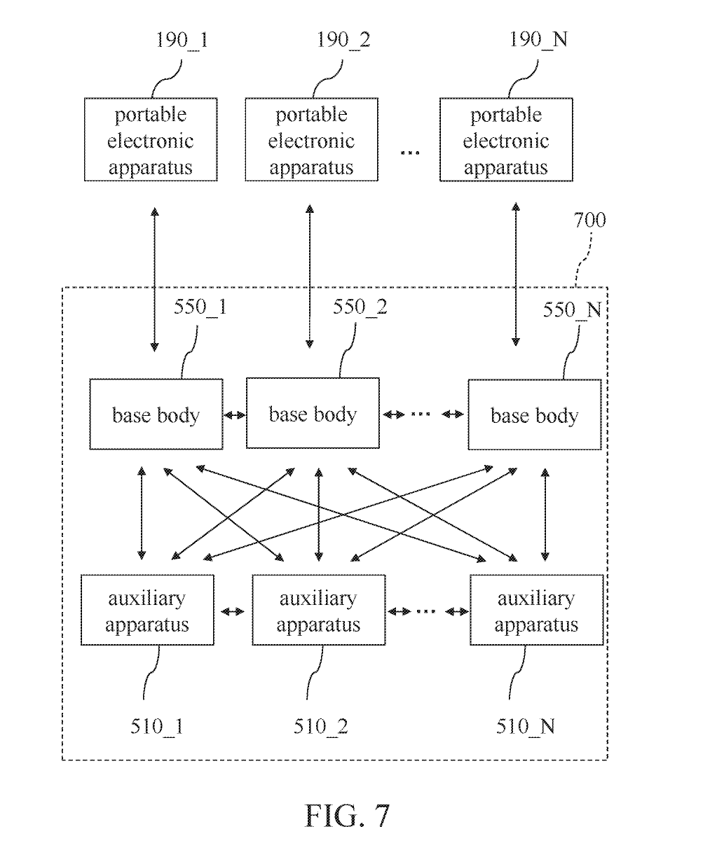

FIG. 7 shows another schematic of a family smart system according to an embodiment of the disclosure. The family smart system includes a plurality of auxiliary apparatuses 510_1˜510_N and a plurality of base bodies 550_1˜550_N, wherein N is a positive integer greater than 1. The internal components and the related operations of the auxiliary apparatuses 510_1˜510_N may refer to the description of the embodiment of the auxiliary apparatus 510 in FIG. 3, and then the description thereof is omitted. Additionally, the base bodies 550_1˜550_N are coupled with each other and communicated with each other, and the internal components and the related operations of the base bodies 550_1˜550_N may refer to the description of the embodiment of the base body 550 in FIG. 4, and the description thereof is omitted. Furthermore, the family smart system 700 corresponds to the portable electronic apparatuses 190_1˜190_N, and the base bodies 550_1˜550_N are one by one correspondingly connected to the portable electronic apparatuses 190_1˜190_N respectively. That is, the base body 550_1 corresponds to the portable electronic apparatus 190_1, the base body 550_2 corresponds to the portable electronic apparatus 190_2, . . . , the base body 550_N corresponds to the portable electronic apparatus 190_N.

In the embodiment, each of the auxiliary apparatuses 510_1˜510_N may be configured with a lookup table, wherein the lookup table records a corresponding relationship of a keyword, a base body and the portable electronic apparatus. For example, the keyword “Hello Jeffery” corresponds to the base body 550_1 and the portable electronic apparatus 190_1, the keyword “Hello Jack” corresponds to the base body 550_2 and the portable electronic apparatus 190_2, and other keywords and other portable electronic apparatuses may refer to the above description.

In one embodiment, after one of the auxiliary apparatuses 510_1˜510_N (for example, the auxiliary apparatus 510_1) receives the first audio signal, the auxiliary apparatus 510_1 may further analyze and identify the first voice signal to obtain a keyword of the first voice signal, such as “Hello Jeffery.” Then, the auxiliary apparatus 510_1 may search in the lookup table according to the keyword of the first voice signal, so as to find a portable electronic apparatus corresponding to the first voice signal, such as the portable electronic apparatus 190_1, and a base body connected to the portable electronic apparatus 190_1, such as the base body 550_1.

Since the portable electronic apparatus corresponding to the first voice signal is the portable electronic apparatus 190_1 and the base body connected to the portable electronic apparatus 190_1 is the base body 200_1, the auxiliary apparatus 510_1 receives the second voice signal and transmits the second voice signal to the base body 550_1, and then the base body 550_1 transmits the second voice signal to the portable electronic apparatus 190_1. After the portable electronic apparatus 190_1 receives the second voice signal, the portable electronic apparatus 190_1 generates the third voice signal according to the second voice signal, wherein the third voice signal is served as the result in response to the second voice signal.

Afterward, the base body 550_1 receives the third voice signal transmitted by the portable electronic apparatus 190_1 through the wireless manner, and transmits the third voice signal to the auxiliary apparatus 510_1 (i.e. the auxiliary apparatus receiving the first voice signal) initially transmitting the second voice signal directly or through other bodies or through other auxiliary apparatuses, such that the auxiliary apparatus 510_1 receives the third voice signal to perform the corresponding operation corresponding to the processing process and play the third voice signal according to the third voice signal.

In another embodiment, after one of the auxiliary apparatuses 510_1˜510_N (for example, the auxiliary apparatus 510_1) receives the first audio signal, the auxiliary apparatus 510_1 may further analyze and identify the first voice signal to obtain a keyword of the first voice signal, such as “Hello Jack.” Then, the auxiliary apparatus 510_1 may search in the lookup table according to the keyword of the first voice signal, so as to find a portable electronic apparatus corresponding to the first voice signal, such as the portable electronic apparatus 190_2, and a base body connected to the portable electronic apparatus 190_2, such as the base body 550_2.

Afterward, the auxiliary apparatus 510_1 may receive the second voice signal and transmits the second voice signal to the base body 550_2 connected to the portable electronic apparatus 190_2 directly or through other auxiliary apparatuses, and the base body 550_2 transmits the second voice signal to the portable electronic apparatus 190_2. After the portable electronic apparatus 190_2 receives the second voice signal, the portable electronic apparatus 190_2 may generate the third voice signal according to the second voice signal, wherein the third voice signal is served as the result in response to the second voice signal.

Then, the base body 550_2 receives the third voice signal transmitted by the portable electronic apparatus 190_2 through the wireless manner, and transmits third voice signal to the auxiliary apparatus 510_1 (i.e. the auxiliary apparatus receiving the first voice signal) initially transmitting the second signal directly or through other base bodies, such that the auxiliary apparatus 510_1 receives the third voice signal, and performs the corresponding operation corresponding to the processing process and play the third voice signal according to the third voice signal. A communication manner among the auxiliary apparatus 510_1, the auxiliary apparatus 550_2 and the remaining portable electronic apparatuses 190_2˜190_N, or a communication manner among each of other auxiliary apparatuses 510_2˜510_N and each of the portable electronic apparatuses 190_2˜190_N may refer to the description of the above embodiments, and the description thereof is omitted.

In the above embodiment, the lookup table records the corresponding relationship of the keyword and the portable electronic apparatus, but is not limited to the disclosure. In another embodiment, the lookup table configured in each of the auxiliary apparatuses 510_1˜510_N records, for example, a corresponding relationship of a voiceprint and the portable electronic apparatus. For example, the voiceprint “A” corresponds to the portable electronic apparatus 190_1, the voiceprint “B” corresponds to the portable electronic apparatus 190_2, and other voiceprints and other portable electronic apparatuses may refer to the above description. Wherein the voiceprint “A,” the voiceprint “B,” . . . correspond to the same word, such as but not limited to “Hello Jeffery.”

In one embodiment, after one of the auxiliary apparatuses 510_1˜510_N (for example, the auxiliary apparatus 510_1) receives the first audio signal, the auxiliary apparatus 510_1 may further analyze and identify the first voice signal to obtain the word and the corresponding voiceprint of the first voice signal, such as “Hello Jeffery” and the corresponding voiceprint “A.” Then, the auxiliary apparatus 510_1 may search and compare in the lookup table according to the voiceprint of the first voice signal, so as to find a portable electronic apparatus corresponding to the first voice signal, such as the portable electronic apparatus 190_1, and an auxiliary apparatus connected to the portable electronic apparatus 190_1, such as the auxiliary apparatus 550_1.

Since the portable electronic apparatus corresponding to the first voice signal is the portable electronic apparatus 190_1 and the base body connected to the portable electronic apparatus 190_1 is the base body 550_1, the auxiliary apparatus 510_1 receives the second voice signal and transmits the second voice signal to the base body 550_1, and then the base body 550_1 transmits the second voice signal to the portable electronic apparatus 190_1. After the portable electronic apparatus 190_1 receives the second voice signal, the portable electronic apparatus 190_1 generates the third voice signal according to the second voice signal, wherein the third voice signal is served as the result in response to the second voice signal.

Afterward, the base body 550_1 receives the third voice signal transmitted by the portable electronic apparatus 190_1 through the wireless manner, and transmits the third voice signal to the auxiliary apparatus 510_1 (i.e. the auxiliary apparatus receiving the first voice signal) initially transmitting the second voice signal directly or through other base bodies or through other auxiliary apparatuses, such that the auxiliary apparatus 510_1 receives the third voice signal, and performs the corresponding operation corresponding to the processing process and plays the third voice signal according to the third voice signal.

In another embodiment, after one of the auxiliary apparatuses 510_1˜510_N (for example, the auxiliary apparatus 510_1) receives the first audio signal, the auxiliary apparatus 510_1 may further analyze and identify the first voice signal to obtain the word and the corresponding voiceprint of the first voice signal, such as “Hello Jeffery” and the corresponding voiceprint “B.” Then, the auxiliary apparatus 510_1 may search and compare in the lookup table according to the voiceprint of the first voice signal, so as to find a portable electronic apparatus corresponding to the first voice signal, such as the portable electronic apparatus 190_2, and a base body connected to the portable electronic apparatus 190_2, such as the base body 550_2.

Afterward, the auxiliary apparatus 510_1 may receive the second voice signal and transmits the second voice signal to the base body 550_2 connected to the portable electronic apparatus 190_2 directly or through other auxiliary apparatuses, and then the base body 550_2 transmits the second voice signal to the portable electronic apparatus 190_2. After the portable electronic apparatus 190_2 receives the second voice signal, the portable electronic apparatus 190_2 may generate the third voice signal according to the second voice signal, wherein the third voice signal is served as the result in response to the second voice signal.

Then, the base body 550_2 receives the third voice signal transmitted by the portable electronic apparatus 190_2 through the wireless manner, and transmits third voice signal to the auxiliary apparatus 510_1 (i.e. the auxiliary apparatus receiving the first voice signal) initially transmitting the second signal directly or through other base bodies or through other auxiliary apparatuses, such that the auxiliary apparatus 510_1 receives the third voice signal, and performs the corresponding operation corresponding to the processing process and play the third voice signal according to the third voice signal. A communication manner among the auxiliary apparatus 510_1, the auxiliary apparatus 550_2 and the remaining portable electronic apparatuses 190_2˜190_N, or a communication manner among each of other auxiliary apparatuses 510_2˜510_N and each of the portable electronic apparatuses 190_2˜190_N may refer to the description of the above embodiments, and the description thereof is omitted.

Therefore, the auxiliary apparatuses 510_1˜510_N may correspond to the portable electronic apparatuses 190_1˜190_N, and analyze and identify the different first voice signal to match to the corresponding portable electronic apparatus, such that each of the auxiliary apparatuses 510_1˜510_N may transmits the following second voice signal to the corresponding portable electronic apparatus and receive the third voice signal transmitted by the corresponding portable electronic apparatus to perform the subsequent process, thereby increasing a convenience of usage.

According to the auxiliary apparatus and the family smart system of the embodiments of the disclosure, the auxiliary apparatus transmits the second voice signal generated by the user to the portable electronic apparatus to process or the auxiliary apparatus and the base body transmit the second voice signal generated by the user to the portable electronic apparatus to process, then the auxiliary apparatus receives the third voice signal generated by the portable electronic apparatus in response to the second voice signal, so as to perform the corresponding operation and play the third voice signal corresponding to the second voice signal according to the third voice signal, or the auxiliary apparatus and the base body receive the third voice signal generated by the portable electronic apparatus in response to the second voice signal, so as to perform the corresponding operation and play the third voice signal corresponding to the second voice signal according to the third voice signal. Additionally, the embodiment may be suitable to a plurality of auxiliary apparatuses corresponding to the a plurality of portable electronic apparatus or a plurality of auxiliary apparatuses and a plurality of base bodies corresponding to a plurality of portable electronic apparatus. Therefore, the user may still perform the voice control operation for the portable electronic apparatus(es) through the auxiliary apparatus(es) or the auxiliary apparatuses(es) and the base body(bodies) in a far distance, thereby increasing a convenience of usage.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substaintial/substaintially” means, within an acceptable error range, the person skilled in the art may solve the technical problem in a certain error range to achieve the basic technical effect. Additionally the term “couple” or “connect” covers any direct or indirect electrically coupling means. Therefore when one device is electrically connected to another device in the context, that connection may be through a direct electrical connection, or through an indirect electrical connection via other devices and connections. The following description is of the best-contemplated mode of carrying out the invention. This description is made for the purpose of illustration of the general principles of the invention and should not be taken in a limiting sense. The scope of the invention is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

Although the disclosure has been explained in relation to its preferred embodiment, it does not intend to limit the disclosure. It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. An auxiliary apparatus, comprising:
a communication unit;
a voice receiving unit;
a voice playing unit; and
a processing unit, coupled to the communication unit, the voice receiving unit and the voice playing unit, receiving a first voice signal by the voice receiving unit to start a processing process of the processing unit, and receiving a second voice signal by the voice receiving unit to transmit the second voice signal to at least one portable electronic apparatus through the communication unit;
wherein the processing unit receives a third voice signal transmitted by the at least one portable electronic apparatus through the communication unit, performs a corresponding operation corresponding to the processing process according to the third voice signal, and transmits the third voice signal to the voice playing unit, so as to play the third voice signal;
wherein the third voice signal corresponds to the second voice signal, and the third voice signal is generated by the at least one portable electronic apparatus in response to the second voice signal.

2. The auxiliary apparatus as claimed in claim 1, wherein the voice playing unit is a horn or a speaker.

3. The auxiliary apparatus as claimed in claim 1, wherein the voice receiving unit comprises one or more microphones.

4. The auxiliary apparatus as claimed in claim 1, further comprising: a power extension socket, coupled to the processing unit and supplying a power to an external apparatus.

5. The auxiliary apparatus as claimed in claim 1, wherein the communication unit conforms a WiFi communication protocol or a power line communication protocol or conforms the WiFi communication protocol and the power line communication protocol at the same time.

6. The auxiliary apparatus as claimed in claim 1, further comprising: a sensing unit, sensing whether an object approaches the auxiliary apparatus to generate a sensing signal, wherein the processing unit receives the sensing signal and triggers the voice receiving unit according to the sensing signal.

7. A system comprising a plurality of auxiliary apparatuses as claimed in claim 1, wherein the plurality of auxiliary apparatuses are communicated with each other, such that the at least one portable electronic apparatus outputs the third voice signal to one of the plurality of the auxiliary apparatuses and then the auxiliary apparatus outputs the third voice signal to the remaining auxiliary apparatuses.

8. The system as claimed in claim 7, wherein a number of the at least one electronic apparatus is more than one, after the processing unit of one of the plurality of auxiliary apparatuses receives the first voice signal, the processing unit finds the portable electronic apparatus corresponding to the first voice signal and the auxiliary apparatus connected with the portable electronic apparatus, such that the auxiliary apparatus receiving the first voice signal transmits the second voice signal to the auxiliary apparatus connected with the portable electronic apparatus, then the auxiliary apparatus connected with the portable electronic apparatus transmits the second voice signal to the corresponding portable electronic apparatus, and the auxiliary apparatus connected with the portable electronic apparatus receives the third voice signal transmitted by the corresponding portable electronic apparatus and then transmits the third voice signal to auxiliary apparatus receiving the first voice signal.

9. A family smart system, comprising:
at least one auxiliary apparatus, comprising:
a first communication unit;
a voice receiving unit;
a first voice playing unit; and
a first processing unit, coupled to the first communication unit, the voice receiving unit and the first voice playing unit, receiving a first voice signal by the voice receiving unit to start a processing process of the first processing unit, and receiving a second voice signal by the voice receiving unit to output the second voice signal through the first communication unit; and
at least one base body, coupled to the first communication unit, receiving the second voice signal, transmitting the second voice signal to the at least one portable electronic apparatus through a wireless manner, and wirelessly receiving a third voice signal generated by the at least one portable electronic apparatus in response to the second voice signal;
wherein the first processing unit receives the third voice signal through the first communication unit, performs a corresponding operation corresponding to the processing process according to the third voice signal, and transmits the third voice signal to the first voice playing unit, so as to play the third voice signal.

10. The family smart system as claimed in claim 10, wherein the at least one base body comprising:
a second communication unit, coupled to the first communication unit and the at least one portable electronic apparatus;
a second voice playing unit; and
a second processing unit, coupled to the second communication unit and the second voice playing unit, the second processing unit receives the second voice signal through the second communication unit in the wireless manner, and transmits the second voice signal to the at least one portable electronic apparatus through the second communication unit in the wireless manner;
wherein the second processing unit receives the third voice signal generated by the at least one portable electronic apparatus in response to the second voice signal through the second communication unit, and outputs the third voice signal to the first communication unit through the second communication unit.

11. The family smart system as claimed in claim 10, wherein the at least one base body further comprises a charging unit, the second processing unit is coupled to the charging unit, the second processing unit detects a connection state of the charging unit and the at least one portable electronic apparatus, and the second processing unit receives the second voice signal through the second communication unit in the wireless manner and transmits the second voice signal to the at least one portable apparatus through the second communication unit in the wireless manner according to the connection state.

12. The family smart system as claimed in claim 10, wherein the second communication unit comprises a first communication protocol and a second communication protocol, the second communication unit is connected to the at least one portable electronic apparatus through the first communication protocol and is connected to the first communication unit through the second communication protocol.

13. The family smart system as claimed in claim 12, wherein the first communication protocol is a bluetooth communication protocol or a WiFi communication protocol, and the second communication protocol is a WiFi communication protocol or a power line communication protocol.

14. The family smart system as claimed in claim 9, further comprising: a power extension socket, coupled to the first processing unit and supplying a power to an external apparatus.

15. The family smart system as claimed in claim 9, further comprising: a sensing unit, sensing whether an object approaches the at least one auxiliary apparatus to generate a sensing signal, wherein the first processing unit receives the sensing signal and triggers the voice receiving unit according to the sensing signal.

16. The family smart system as claimed in claim 10, wherein the second voice playing unit is a horn or a speaker.

17. The family smart system as claimed in claim 9, wherein the first voice playing unit is a horn or a speaker.

18. The family smart system as claimed in claim 9, wherein the voice receiving unit comprises one or more microphones.

19. The family smart system as claimed in claim 9, wherein a number of the at least one auxiliary apparatus is more than one, wherein the at least one base body outputs the third voice signal to one of the auxiliary apparatuses, such that the one of the auxiliary apparatuses performs the corresponding operation corresponding to the processing process and plays the third voice signal according to the third voice signal.

20. The family smart system as claimed in claim 19, wherein the auxiliary apparatus are communicated with each other, such that the at least one base body outputs the third voice signal to one of the auxiliary apparatuses, and then the auxiliary apparatus outputs the third voice signal to the remaining auxiliary apparatus.

21. The family smart system as claimed in claim 9, wherein a number of the at least one auxiliary apparatus is more than one, a number of the at least one portable electronic apparatus is more than one, a number of the at least one base body is more than one, the portable electronic apparatuses are respectively corresponded to and connected to the base bodies, wherein after the first processing unit of one of the auxiliary apparatuses receives the first voice signal, the first processing unit finds the portable electronic apparatus corresponding to the first voice signal and the base body connected to portable electronic apparatus, such that the auxiliary apparatus receiving the first voice signal outputs the second voice signal to the base body connected to the portable electronic apparatus and the base body connected to the portable electronic apparatus transmits the second voice signal to the corresponding portable electronic apparatus, and the base body connected to the portable electronic apparatus receives the third voice signal transmitted by the corresponding portable electronic apparatus and outputs the auxiliary apparatus receiving the first voice signal directly or through other base bodies or other auxiliary apparatuses.
